(19) United States
(12) Patent Application Publication
(10) Pub. No.: US 2012/0121798 A1
(43) Pub. Date: May 17, 2012

(54) CONDUCTOR PASTE FOR RAPID FIRING

(75) Inventors: Ken-ichi Sugimura, Nishikamo-gun (JP); Kazuhisa Hirao, Nishikamo-gun (JP)

(73) Assignee: NORITAKE CO., LTD., Nagoya-shi (JP)

(21) Appl. No.: 13/358,686

(22) Filed: Jan. 26, 2012

Related U.S. Application Data
(62) Division of application No. 12/236,568, filed on Sep. 24, 2008.

(30) Foreign Application Priority Data
Sep. 26, 2007 (JP) 2007-249070

(51) Int. Cl. B05D 5/12; B05D 3/02

(52) U.S. Cl. 427/79; 427/58

(57) ABSTRACT

The present invention provides a conductor paste for rapid firing that is applied to a ceramic green sheet and is fired along with the green sheet under high-rate temperature rise conditions at a high heating rate of at least 600° C./hr from room temperature to the maximum firing temperature. The paste includes as a conductor-forming powder material: a conductive metallic powder comprising, as a main component, nickel powder; and barium titanate ceramic powder with a mean particle diameter of 10 nm to 80 nm as an additive. The ceramic powder content is 5 to 25 mass parts per 100 mass parts of the conductive metallic powder.

### CROSS-REFERENCE TO RELATED APPLICATIONS

This application is a Division of application Ser. No. 12/236,568 filed Sep. 24, 2008, the entire contents of which are hereby incorporated herein by reference.

The present application also claims priority right based on Japanese Patent Application 2007-249070 filed on Sep. 26, 2007 and hereby incorporated by reference.

### BACKGROUND OF THE INVENTION

1. Field of the Invention

The present invention relates to a conductor paste used for applications in which conductors (such as internal electrodes) are formed in multi-layered ceramic capacitors and other ceramic electronic components (including various circuit elements).

2. Description of the Related Art

The smaller sizes and greater precision of recent electronic devices has been accompanied by greater demand for smaller sizes, greater capacity, and higher performance in ceramic electronic components such as multi-layered ceramic capacitors (MLCC). One way to accomplish this is to increase the performance of conductor films (refers to conductors in general formed in the shape of a thin layer, and the same applies hereinafter) such as electrodes or wiring in ceramic electronic components.

A typical method for forming conductor films such as the above is to apply a conductor paste of a conductive metallic powder dispersed in a suitable medium (vehicle) onto a ceramic green sheet (unfired ceramic base) and then fire the applied conductor paste along with the green sheet (simultaneous firing), giving a fired conductor film. The conductor paste for forming MLCC internal electrodes is preferably one in which the conductive metallic powder is primarily a nickel powder (a metallic powder composed of nickel or a nickel-based alloy, referred to below as “Ni powder”). Conventional technical references on conductor pastes used in the production of MLCC include Japanese Laid-Open Patent Application Nos. 2000-216042, 2007-53287, 2006-269320, and 2005-25952.

### SUMMARY OF THE INVENTION

The simultaneous firing of the conductor paste and green sheet as noted above can generally be divided into a process for heating the material that is to be fired to the maximum firing temperature as befits the type of conductive metallic powder, a process for holding the material for a certain period of time at the maximum firing temperature, and a process for cooling the material. In conventional methods for forming conductor films by simultaneously firing a green sheet and a conductor paste in which the conductive metallic powder is based on nickel powder (Ni paste), the maximum firing temperature is about 1200° C. to 1400° C., the heating process is carried out at a heating rate of about 200 to 400° C./hr, and it generally takes a long time of about 20 hours or more until the series of firing processes is complete (that is, from the introduction of the material that is to be fired into the firing furnace until the resulting fired product is taken out of the furnace).

Recently developed firing furnaces, however, have a heating function for carrying out the heating process at a heating rate of at least 600° C./hr, which allows the series of firing processes to be completed within 2 hours, for example (rapid firing furnaces). The use of such rapid firing is desirable in terms of energy efficiency as well as in terms of the productivity of ceramic electronic components. Japanese Laid-Open Patent Application No. 2000-216042 describes a technique for heating a conductor paste between 700° C. and 1100° C. at a rate of at least 500° C./hr in a conductor paste firing process. Japanese Laid-Open Patent Application No. 2007-53287 also describes a technique in which the heating rate is at least 800° C./hr when unfired ceramic chips (having unfired internal electrodes comprising a printed conduction paste) are fired.

However, in the techniques described in Japanese Laid-Open Patent Application No. 2000-216042 or Japanese Laid-Open Patent Application No. 2007-53287, conductor pastes with compositions suitable for firing under conventional firing conditions at a heating rate of about 200 to 400° C./hr (slow heating) are merely used as such in rapid firing at a heating rate of 600° C./hr or more (rapid heating). In other words, the composition of specialized conductor pastes for applications involving rapid heating instead of slow heating (that is, conductor pastes for rapid firing) was not adequately studied. Increases in the performance of the conductor films formed by rapid firing are therefore limited.

An object of the invention, which is a conductor paste for rapid firing along with a ceramic green sheet, wherein the conductive metallic powder is based on nickel powder (Ni paste), is to provide a conductor paste for rapid firing allowing a high performance conductor film to be formed by rapid firing.

Generally added to the conductor paste for simultaneous firing is a ceramic powder for minimizing the difference in firing shrinkage between the green sheet and the conductor film (unfired conductor pattern) that has been formed upon the application of the conductor paste to the ceramic green sheet, so as prevent structural defects, breakage, or the like while preserving the desired adhesive strength. A barium titanate ceramic powder (BT powder) with a mean particle diameter of 0.1 μm or more (such as 0.1 μm to 1 μm) is commonly used in Ni pastes that are fired under conventional firing conditions at a heating rate of about 200 to 400° C./hr (slow heating). That is because it is known that BT powder with a mean particle diameter significantly lower than 0.1 μm will not provide enough of an effect for practical use (firing shrinkage permitting the formation of a conductor film free of structural defects, breakage, or the like), or that the minimum amount of BT powder which must be added to achieve any effect will clearly be greater than BT powder with a mean particle diameter of at least 0.1 μm (see FIG. 2) and will thus tend to lower the electrical properties (such as conductivity) or the stability of the quality of the resulting conductor films.

As a result of detailed study on the relationship between the mean particle diameter of the BT powder and the amount in which it is added, the inventors found that the common technical knowledge relevant to conventional slow heating is overturned under rapid firing conditions of 600° C./hr or more. The present invention was perfected upon the discovery of a conductor paste for rapid firing, which is fired under such high-rate temperature rise conditions to form a conductor film having particularly high performance.

That is, the present invention is intended to provide a conductor paste for rapid firing, which is applied to a ceramic green sheet and is fired along with the green sheet under high-rate temperature rise conditions at a high heating rate of at least 600° C./hr from room temperature to the maximum firing temperature (preferably 1000° C. to 1400° C., and typically 1200° C. to 1400° C.). The conductor paste contains as conductor-forming powder material a conductive metallic powder (preferably a conductive metallic powder with a mean particle diameter of 0.05 μm to 0.5 μm and typically 0.1 μm to 0.4 μm) comprising nickel powder as a main component; and barium titanate ceramic powder (BT powder) with a mean particle diameter of 10 nm to 80 nm (and preferably 10 nm to 50 nm) as an additive. The content of the BT powder is 5 to 25 mass parts (and preferably 5 to 15 mass parts) per 100 mass parts conductive metallic powder.

A conductor paste having this structure can be fired at or over a certain heating rate using only a small amount of a small particle diameter BT powder that would not provide enough of an effect or that would have to be added in greater amounts in pastes fired under conventional conditions, thereby allowing the desired effects (controlling firing shrinkage) to be brought about and a high performance (e.g. better electrical properties such as resistivity) conductor films to be formed.

In terms of specifying the present invention, “mean particle diameter” refers to an approximate value that is deduced on the basis of the particle diameter of primary particles forming the powder (fine particles). The mean particle diameter is typically calculated by electron microscopy such as scanning electron microscopy (SEM).

A preferred embodiment of the conductor paste disclosed here is a conductive paste in which the coverage [%], as represented by the following formula, is at least 75%, when the conductor paste is applied to a ceramic green sheet and is fired with a temperature profile in which the paste is heated from room temperature to the maximum firing temperature (typically 1200° C. to 1400° C., such as 1250° C.) at a heating rate of 3600° C./hr, is held at the maximum firing temperature for 40 to 60 minutes, and is then cooled to room temperature, thereby forming a conductor film on a ceramic base:

(area of a portion, which is covered with conductor film, of fired ceramic base)/(area, to which conductor paste has been applied, of ceramic green sheet)×100.

A conductor paste capable of such coverage can be fired at a heating rate of at least 600° C./hr (the firing conditions may be the same as or different from the temperature profile noted above) to bring about better control of firing shrinkage and form a conductor film with higher performance (e.g. better electrical properties such as resistivity).

The conductor paste disclosed here is preferably in the form of a paste for forming the internal electrodes of multi-layered ceramic capacitors (MLCC). The conductor paste is suitable for making thinner internal electrodes (and thus a smaller MLCC overall) because lower amounts of BT powder are added to achieve the desired effect, and the better electrical properties can contribute to higher performance MLCC. Furthermore, since the conductor paste disclosed here is a conductor paste for rapid firing, the production efficiency of MLCC can be enhanced.

The present invention also provides a method for producing conductor films (for example, MLCC internal electrodes), including the steps of applying any of the conductor pastes disclosed here to a ceramic green sheet, and firing the applied conductor paste along with the green sheet under heating conditions where a heating rate is at least 600° C./hr from room temperature to the maximum firing temperature and the maximum firing temperature is 1000° C. to 1400° C. (and typically 1200° C. to 1400° C.). This method allows a thin conductor film having good electrical properties to be formed rapidly (and thus with better productivity).

Another aspect of the invention is the provision of a method for producing MLCC and other ceramic electronic components, which includes using any of the conductor pastes disclosed here. This method typically includes a step for applying any of the conductor pastes disclosed here onto a ceramic green sheet, and a step for firing the applied paste along with the green sheet. This method can produce and provide an MLCC or other ceramic electronic component having better electrical and mechanical properties suitable for smaller sizes, greater capacity, and higher performance.

### BRIEF DESCRIPTION OF THE DRAWINGS

FIG. 1 is a cross section schematically illustrating the structure of the a common multi-layered ceramic capacitor;

FIG. 2 is a characteristics diagram showing the relationship of BT powder mean particle diameter and amount used to coverage at a heating rate of 200° C./hr;

FIG. 3 is a characteristics diagram showing the relationship of BT powder mean particle diameter to coverage when the BT powder is used in an amount of 15 mass parts per 100 mass parts Ni powder;

FIG. 4 is a characteristics diagram showing the relationship of BT powder mean particle diameter and amount used to coverage; and

FIG. 5 is a characteristics diagram showing the relationship of BT powder mean particle diameter and amount used to coverage.

### DETAILED DESCRIPTION OF THE INVENTION

Preferred embodiments of the invention are described below. Matters necessary to working the invention, other than what is specifically mentioned in the Specification, can be understood as matters of design to those having ordinary skill in the art based on the prior art in related fields. The present invention can be worked based on details disclosed in the Specification and common technical knowledge in related fields.

The conductor paste disclosed here is a Ni paste for rapid firing that is used to form conductor films by being fired at a certain heating rate, characterized by including a certain proportion of conductive metallic powder based on Ni powder as inorganic/metallic powder material for forming the conductor film and BT powder with a mean particle diameter within a certain range as an additive (that is, conductor-forming powder material).

The conductive metallic powder constituting the conductor-forming powder material in the above conductor paste is at least 50 mass %, and preferably at least 75 mass %, Ni powder among the conductive metallic powder. In a preferred embodiment of the conductor paste disclosed here, the conductive metallic powder is substantially composed of Ni powder. The mean particle diameter of the particles forming the conductive metallic powder is preferably 0.05 μm to 0.5 μm, more preferably 0.1 μm to 0.4 μm, and even more preferably 0.15 μm to 0.3 μm (such as around 0.2 μm). The Ni powder and other conductive metallic powder having the above preferred mean particle diameter can be readily produced by known methods or readily obtained in the form of a commercial product.

The mean particle diameter of the particles forming the BT powder (typically barium titanate powder) is 10 nm to 80 nm (typically 20 nm to 70 nm). A conductor paste in which the mean particle diameter of the BT powder is 20 nm to 50 nm (and more preferably 20 nm to 40 nm, such as around 30 nm) will allow particularly good effects to be achieved. BT powder having such a mean particle diameter can be readily produced (synthesized) by known methods or readily obtained in the form of a commercial product.

The conductor paste disclosed here includes BT powder having such a mean particle diameter in a proportion of 5 to 25 mass parts (and preferably 5 to 20 mass parts, such as 12.5 to 17.5 mass parts, or 5 to 15 mass parts) per 100 mass parts conductive metallic powder. A BT powder content that is too far over this range may have an undesirable effect on the electrical properties of the resulting conductor film or ceramic electronic component having such a conductor film (such as MLCC) that formed when the conductor paste has been fired under certain rapid firing conditions. On the other hand, if the BT powder content is too far under the above range, the effect (in preventing firing shrinkage) of adding the BT powder may be insufficient, and problems such as structural defects or breakage may tend to occur in the conductor films that are formed when the conductor paste is fired under certain high-rate temperature rise conditions. If the mean particle rate of the BT powder is too far over the above range, the preferred amount may not be enough to achieve the desired effects.

The extent to which the above firing shrinkage is controlled can be determined using as an indicator the coverage that is determined by tests under the following conditions, for example. The higher the coverage, the greater the effect in controlling firing shrinkage as a result of the addition of the BT particles under the firing conditions (that is, the lower the firing shrinkage).

The conductor paste is applied to a ceramic green sheet (preferably a ceramic green sheet based on a barium titanate ceramic), the green sheet with the applied conductor paste is typically fired with the following temperature profile (the material is heated from room temperature to the maximum firing temperature at a heating rage of 3600° C./hr, held for 40 to 60 min at the maximum firing temperature, and then cooled to room temperature) after the debindering method described below to give a fired product comprising a conductor film formed on the ceramic base, and the coverage is determined by substituting the area (A1) of the ceramic green sheet to which the conductor paste has been applied and the area (A2) of the portion where the conductor films cover the ceramic base (fired ceramic base) in the fired product into the following formula.

Coverage [%]=(A2/A1)×100

The above areas can be measured by analyzing images obtained preferably through electron microscopy such as SEM of the fired object. The above image analysis can be done visually, for example. Suitable image analysis software can also be used as needed.

The range of the coverage serving as a guide for ensuring that firing shrinkage is controlled sufficiently for practical purposes is at least 60% (typically 60% to 95%), and preferably at least 65% (typically 65% to 95%). Coverage of at least 70% (typically 70% to 95%) is more desirable, and at least 75% is particularly desirable. A conductor paste in which such coverage is achieved with an even lower amount of BT powder is preferred because firing shrinkage will be controlled enough for practical purposes and a conductor film with better electrical properties (such as resistivity) can be formed. Conductor pastes with such lower amounts of BT powder are also beneficial for producing thinner film-shaped electrodes (and thus smaller ceramic electronic components such as MLCC that have conductor films). A conductor paste that is composed so that the coverage is 70% to 95% (and preferably 80% to 95%) is preferred in the interests of achieving a good balance between controlling firing shrinkage and electrical properties. A preferred embodiment of the conductor paste disclosed here is a conductor paste in which the coverage is at least 85% (typically 85% to 95%).

The conductor paste disclosed here can be a conductor paste that is fired under high-rate temperature rise conditions at a rate of at least 600° C./hr (preferably at least 1500° C./hr, such as at least 3000° C./hr) while the amount of BT powder that is used is a low amount of 5 to 20 mass parts (the amount could be 12.5 to 17.5 mass parts or 5 to 15 mass parts) per 100 mass parts conductive metallic powder (typically Ni powder) to form a conductor film in which the coverage is at least 65% (preferably at least 70%, and more preferably at least 75%).

In a preferred embodiment of the conductor paste disclosed here, the conductor paste (Ni paste) will give a conductor film having coverage of at least 70% (preferably at least 75%) when a green sheet with the applied conductor paste is typically fired, after a debindering process, with a temperature profile in which the material is heated from room temperature to the maximum firing temperature (typically 1200° C. to 1400° C., such as around 1250° C.) at a heating rate of 3600° C./hr, then held for 40 to 60 min (such as 60 min) at the maximum temperature, and then cooled to room temperature (cooled, for example, at a cooling rate of 3600° C./hr). A conductor paste producing such coverage can be fired under conditions meeting a heating rate of at least 600° C./hr (the firing conditions may be the same as or different from the above temperature profile, and the firing conditions will preferably result in coverage of at least 65%, preferably not less than 70%, and more preferably not less than 75%) to provide better control of firing shrinkage and form a high performance conductor film.

Accessory components constituting the conductor paste of the invention will be described next. The conductor paste of the invention can include the same substances as conventional conductor pastes as accessory components in addition to the above conductor film-forming powder material (in a preferred typical example, the conductor-forming powder material is substantially composed of Ni powder and BT powder). An example of an essential accessory component of the conductor paste in the invention is an organic medium (vehicle) in which the conductor-forming powder material is dispersed. In working the present invention, the organic vehicle should be one allowing the conductor-forming powder material to be suitably dispersed, and any employed in conventional conductor pastes can be used. Examples which can be used are organic vehicles containing as constituents high-boiling organic solvents or combinations of two or more of these solvents, such as ethyl cellulose or other cellulose polymers, ethylene glycol and diethylene glycol derivatives, toluene, xylene, mineral spirits, butyl carbitol, and terpineol. The organic vehicle content may be, but is not limited to, 10 to 60 mass % of the paste as a whole.

The conductor paste of the invention can also include the same various organic additives used in conventional conductor pastes as needed. Examples of such organic additives include various organic binders (binders that are the same as or different from the above vehicles may be added), and silicone-based, titanate-based, aluminum-based or other various coupling agents for improving adhesion with the ceramic base. Examples of organic binders include those based on acrylic resin, epoxy resin, phenolic resin, alkyd resin, cellulose polymers, polyvinyl alcohol, and polyvinyl butyral. Those capable of endowing the conductor paste of the invention with good viscosity and film (film on base) forming capacity are preferred. A variety of photopolymerization compounds and photopolymerization initiators may be added as needed to endow the conductor paste of the invention with light curing properties (photosensitivity).

Surfactants, defoamers, plasticizers, thickeners, antioxidants, dispersants, polymerization inhibitors, and the like can also be added as needed to the conductor paste of the invention in addition to the above. The additives should be those that can be used to prepare conventional conductor pastes, and will not be further elaborated as they do not particularly characterize the present invention.

The preparation of the conductor paste of the invention will be described next. The conductor paste of the invention can be readily prepared, typically by mixing the conductor-forming powder material and an organic medium (vehicle) in the same manner as conventional conductor pastes. The conductive metallic powder and BT powder forming the conductor-forming powder material may be added separately to the vehicle, or previously mixed and added to the vehicle. The above additives may be added or mixed as needed at that time. For example, the conductor-forming power material and various additives may be directly blended and kneaded (mixed) together in the prescribed proportions along with the organic vehicle using a three-roll mill or other kneader to prepare the conductor paste (can also be conceived of a sink or slurry) of the invention.

Preferred examples related to the formation of conductor films (that is, the production of ceramic electronic components) using the conductor paste of the invention will be described next. The conductor paste of the invention can be handled in the same manner as conductor pastes conventionally used to form conductor films such as electrodes and wiring on a ceramic base (substrate) except that it is fired under certain rapid firing conditions (that is, firing conditions including a process for heating from ordinary temperature (typically room temperature) to the maximum firing temperature at a rate of at least 600° C./hr), and any conventional method can be employed. Typically, the conductor paste is applied by screen printing, dispenser application or the like in the desired shape and thickness onto an unfired ceramic base (ceramic green sheet). The green sheet used here will preferably be one having the same ceramic composition as the BT powder, that is, a green sheet obtained using barium titanate ceramic powder (barium titanate green sheet). The amount of conductor paste applied is not particularly limited. To form Ni internal electrodes for an MLCC, for example, the amount is generally about 0.2 to 0.7 mg/cm², based on the mass of the nickel powder.

The green sheet with the applied conductor paste (material to be fired) is then heated according to a certain temperature profile to fire (bake) and cure the applied paste component. This series of processing will give a ceramic electronic product on which the target thin conductor films (wiring, electrodes, etc.) have been formed (such as ceramic wiring substrates for building multi-tip modules, hybrid IC, or MLCC electrodes). More sophisticated ceramic electronic components (such as hybrid IC or multi-tip modules) can be obtained through conventional methods using ceramic electronic components as assembly materials.

Here, the temperature profile that is used when heating the green sheet with the applied conductor paste (that is, when the conductor paste is fired) includes at least a process for heating from ordinary temperature (typically room temperature) to the maximum firing temperature Tmax at a heating rate ΔT1 of at least 600° C./hr (typically 600 to 10000° C./hr, such as 1200 to 4000° C./hr). The heating rate ΔT1 is preferably at least 1500° C./hr (typically 1500 to 4000° C./hr), and more preferably at least 3000° C./hr (typically 3000 to 4000° C./hr). the maximum firing temperature Tmax can be, for example, 1000° C. to 1400° C., preferably 1050° C. to 1400° C. (such as 1150° C. to 1300° C.), and even more preferably 1200° C. to 1400° C. (such as 1200° C. to 1300° C.).

In a preferred embodiment for firing the conductor paste disclosed here, the material is held for a certain period of time (holding time H) at the maximum firing temperature Tmax after being heated at the rate ΔT1 to the temperature Tmax. The holding time H can be about 15 min to 3 hours, for example, and is usually about 30 min to 2 hours (such as about 40 min to 60 min). The holding time H may also be 0 min (that is, cooling is started immediately after the maximum firing temperature has been reached). The material is then cooled to give a product (fired product) comprising conductor films formed on a ceramic base. Although the cooling rate during the cooling process is not particularly limited, a cooling rate of about 200 to 7200° C./hr (such as 400 to 4000° C./hr) is preferably used. The material may also be allowed to cool naturally (cool off). The firing process is also suitably carried out in a non-oxidizing atmosphere, and is preferably carried out in a reducing atmosphere (such as an atmosphere of a hydrogen gas and nitrogen gas mixture, and preferably a N₂ atmosphere containing about 1 to 5 mol % H₂). The conductor paste disclosed here is particularly suitable for applications in which the material to be fired is introduced into a furnace (heating device) and is then fired under rapid firing conditions for no more than 5 hours (such as 1 to 5 hours), preferably no more than 3 hours (such as 1 to 3 hours), and even more preferably no more than 2 hours (such as 1 to 2 hours) until the fired product is obtained (until taken out of the firing furnace).

A debindering process (degreasing) is usually preferably carried out before the heating process at the rate ΔT1 (rapid heating). The debindering process is carried out in such a way as to ensure the suitable removal of the binder component (typically organic components such as organic binder) included in the conductor paste (preferably the conductor paste and a ceramic green sheet that is fired along with the paste), and can be carried out in the same manner as common debindering processes. An example of a debindering method (conditions) that can be used includes, but is not particularly limited to, one in which the green sheet with the applied conductor paste is held for about 8 to 12 hours at a temperature of about 300° C. to 400° C. in a certain gas atmosphere (preferably a non-oxidizing atmosphere, e.g. an inert gas atmosphere such as N₂). After such a debindering process has been carried out, the material is typically fired with the above temperature profile once it has cooled to room temperature. Alternatively, the material may be fired (such as under high-rate temperature rise conditions at a heating rate of at least 600° C./hr from the debindering temperature to the maximum firing temperature) at the temperature profile without waiting for the material to cool after the debindering process.

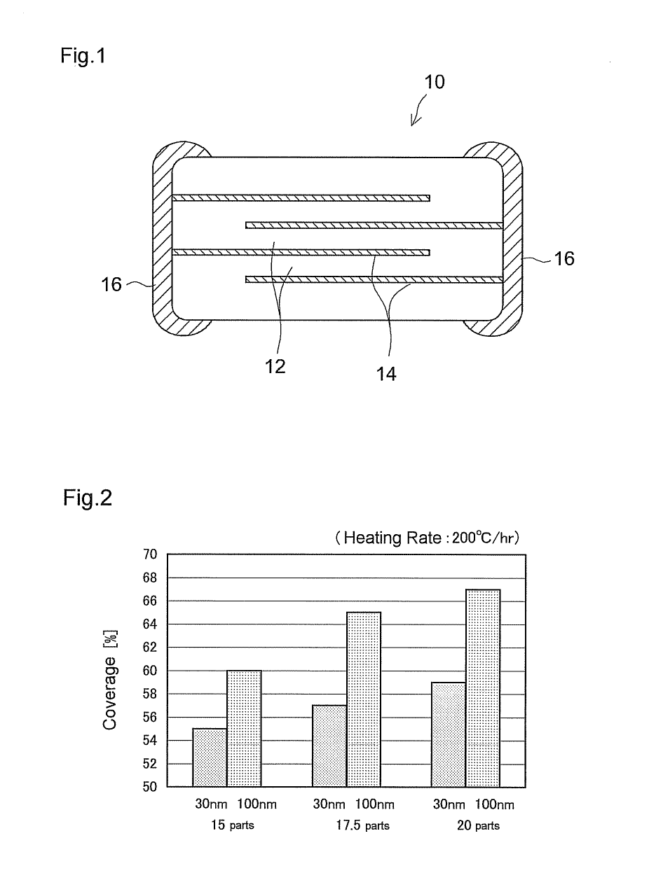

FIG. 1 shows an example of the structure of an MLCC preferably produced using the conductor paste for rapid firing in the invention. This multi-layered ceramic capacitor (MLCC) 10 has a structure in which dielectric layers 12 and internal electrodes 14 are stacked on top of each other, and the internal electrodes 14 that are exposed at the two opposite ends of the stack are connected to end electrodes (external electrodes) 16 that cover both ends. The conductor paste for rapid firing in the invention can preferably be used in applications for forming the internal electrodes (conductor films) 14 of the MLCC 10 having such a structure. For example, several products comprising conductor paste applied in a certain pattern on a ceramic green sheet that has dielectric layers 12 can be produced by firing, and can be stacked (preferably integrated by compression in the stacked direction). The stack (product to be fired) is then fired at the preferred temperature profile noted above to give a fired product with a structure in which the dielectric layers 12 and internal electrodes 14 are stacked on top of each other. A conductor paste for end electrodes (a paste that is the same as or different from the conductor paste used to produce the internal electrodes may be used) is then applied to both ends of the fired product, and is heated and fired to form the end electrodes 16. The MLCC 10 can be produced in this manner.

### EXAMPLES

Some examples of the invention are described below, but it is not intended that the invention should be limited to the specific examples that are given.

100 mass parts (referred to below simply as “parts”) of nickel powder with a mean particle diameter of about 0.2 μm and 15 parts barium titanate powder (BT powder) with a mean particle diameter of about 30 nm were measured out, and were stirred and mixed to prepare a conductor-forming powder material. Ni paste was then prepared using this conductor-forming powder material. That is, the materials were measured out a final paste composition (mass ratio) of 57.5 mass % conductor-forming powder material, with the remainder consisting of vehicle (40.5 mass % solvent and 2 mass % binder), and the materials were kneaded using a three-roll mill. The Ni paste of Example 1 was prepared in this manner.

The Ni pastes of Examples 2 through 6 were prepared in the same manner as the Ni paste of Example 1 except that the mean particle diameters of the BT powders that were used and the amounts of the BT powder relative to 100 mass parts Ni powder were changes as shown in Table 1 (the amount of solvent was adjusted as the amount of BT powder was increased). Table 1 also shows the mean particle diameter of the BT powder that was used to prepare the Ni paste of Example 1 as well as the amount of the BT powder relative to 100 parts Ni powder.

TABLE 1

| | Mean particle diameter | Amount of BT |
|---|---|---|
| | of BT powder (nm) | powder (parts) |
| Example 1 | 30 | 15.0 |
| Example 2 | 30 | 17.5 |
| Example 3 | 30 | 20.0 |
| Example 4 | 100 | 15.0 |
| Example 5 | 100 | 17.5 |
| Example 6 | 100 | 20.0 |

Film-shaped conductors were produced using the Ni pastes of Examples 1 through 6. That is, Ni paste was applied in an amount of 0.45 to 0.51 mg/cm², based on the mass of the Ni powder, onto ceramic green sheets based on barium titanate ceramic. They were introduced into a radiation heating type rapid firing furnace and fired with the following temperature profile in an N₂ atmosphere containing about 5 mol % H₂ (that is, a 5% H₂ and 95% N₂ mixed gas atmosphere). This resulted in the formation of Ni-based conductor films on barium titanate substrates.

1. Heated from room temperature to the maximum firing temperature Tmax [° C.] at a rate ΔT1 [° C./hr].

2. After 1 above, held for a certain holding time H [min] at the maximum firing temperature.

3. After 2 above, cooled from the maximum firing temperature to room temperature.

Here, the maximum firing temperature Tmax was 1250° C., the heating rate ΔT1 was 200° C., and the holding time H was 60 min.

SEM images (×750 magnification) of the resulting conductor films were visually analyzed, and the coverage was calculated by substituting the area (A1) of the ceramic green sheet to which the conductor paste has been applied and the area (A2) of the portion where the conductor films cover the ceramic base (fired ceramic base) in the fired product into the formula noted above. The conductor films were each observed in three places, and the mean was used as the conductor film coverage [%].

FIG. 2 shows that, with all of the amounts of BT powder, the coverage of the conductor films obtained using BT powder with a mean particle diameter of 30 nm was far lower than the coverage obtained using BT powder with a mean particle diameter of 100 nm. Also, despite a tendency for the coverage to increase as the amount of BT powder was increased, the coverage was under 60% even with the use of BT powder in an amount of 20.0 g per 100 g Ni powder when the mean particle diameter of the BT powder was 30 nm.

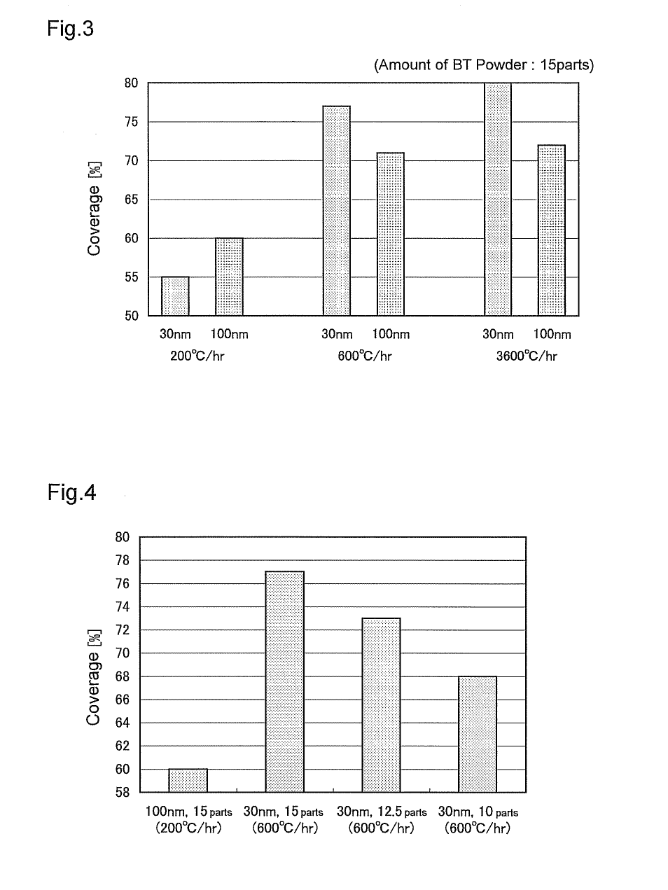

The Ni pastes of Examples 1 and 4 were then used to form conductor films in the same manner as above except that the heating rate ΔT1 was 600° C./hr or 3600° C./hr, and the conductor film coverage was determined in the same manner as above. The results are given in FIG. 3.

FIG. 3 shows that the relationship between the mean particle diameter of the BT powder that is used and the Ni powder coverage is completely inverted under high-rate temperature rise conditions at a heating rate of at least 600° C./hr (600° C./hr or 3600° C./hr) compared to when the heating rate is 200° C./hr. That is, at a heating rate of 600° C./hr and 3600° C./hr, BT powder with a mean particle diameter of 30 nm could be used, in contrast to when the heating rate was 200° C./hr, to achieve far higher coverage compared to when BT powder with a mean particle diameter of 100 nm was used. More specifically, under firing conditions with a heating rate of at least 600° C./hr, a high coverage of at least 75% could be achieved by heating a small amount of BT powder of 15 parts per 100 parts Ni powder.

Ni pastes of Examples 7 through 11 were prepared in the same manner as the Ni paste of Example 1 except that the mean particle diameters of the BT powders that were used and the amounts of the BT powder relative to 100 parts Ni powder were changed as shown in Table 2.

TABLE 2

| | Mean particle diameter | Amount of BT |
|---|---|---|
| | of BT powder (nm) | powder (parts) |
| Example 7 | 30 | 12.5 |
| Example 8 | 30 | 10.0 |
| Example 9 | 50 | 15.0 |
| Example 10 | 50 | 12.5 |
| Example 11 | 50 | 10.0 |

The Ni pastes of Examples 7 and 8 were used to form conductor films in the same manner as above except that the heating rate ΔT1 in the temperature profile was 600° C./hr, and the coverage of the conductor films was determined in the same manner as above. The results are given in FIG. 4. FIG. 4 gives the coverage determined above for conductor films obtained by firing the Ni paste of Example 1 at a heating rate of 600° C./hr, as well as the coverage determined above for conductor films (prior art) obtained by firing the Ni paste of Example 4 at a heating rate of 200° C./hr.

FIG. 4 shows that, in contrast to the conductor films (coverage 60%) of the prior art obtained by firing the Ni paste of Example 4 at a heating rate of 200° C./hr, the conductor films obtained by firing the Ni paste of Example 1 at a heating rate of 600° C./hr had far higher coverage using the same amount of BT as Example 4 (15 parts). The conductor films obtained by firing the Ni pastes of Examples 7 and 8 at a heating rate of 600° C./hr also had clearly higher coverage than Example 4 despite being a composition in which lower amounts of BT had been added than Example 4 (thus affording better conductivity).

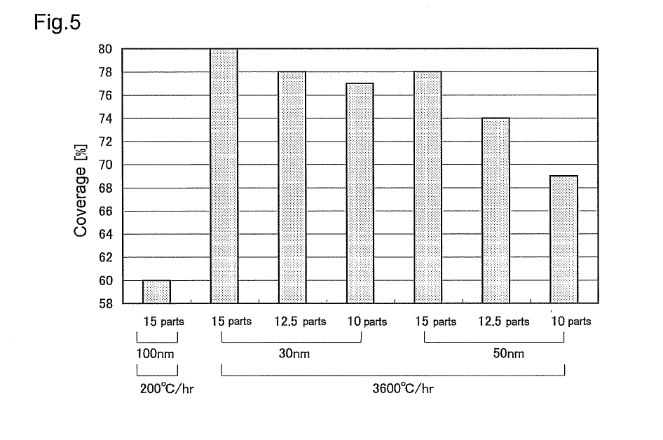

The Ni pastes of Examples 7 through 11 were fired in the same manner as above except that the heating rate ΔT1 was 3600° C./hr, and the coverage of the resulting conductor films was determined in the same manner as above. The results are given in FIG. 5. FIG. 5 gives the coverage determined above for conductor films obtained by firing the Ni paste of Example 1 at a heating rate of 3600° C./hr, as well as the coverage determined above for conductor films (prior art) obtained by firing the Ni paste of Example 4 at a heating rate of 200° C./hr.

FIG. 5 shows that, in contrast to the conductor films (coverage 60%) of the prior art obtained by firing the Ni paste of Example 4 at a heating rate of 200° C./hr, the conductor films obtained by firing the Ni pastes of Examples 1 and 9 at a heating rate of 3600° C./hr had far higher coverage using the same amount of BT as Example 4 (15 parts). The conductor films obtained by firing the Ni pastes of Examples 7, 8, 10, and 11 at a heating rate of 3600° C./hr also had clearly higher coverage than Example 4 despite being compositions in which lower amounts of BT had been added than Example 4 (thus affording better conductivity).

BT powder with a mean particle diameter of 30 nm was used to prepare conductor pastes in the same manner as Example 1 except that the amounts of BT powder used per 100 parts Ni powder were changed to 17.5 parts and 20.0 parts. The conductor pastes were fired under the above conditions at a heating rate ΔT1 of 600° C./hr, and the coverage was determined in the same manner as above. 79% coverage was obtained with 17.5 parts of BT powder, and 80% coverage was obtained with 20.0 parts BT powder, indicating high coverage.

BT powder with a mean particle diameter of 50 nm was used to prepare conductor pastes in the same manner as Example 1 except that the amounts of BT powder used per 100 parts Ni powder were changed to 17.5 parts and 20.0 parts. The conductor pastes were fired under the above conditions at a heating rate ΔT1 of 3600° C./hr, and the coverage was determined in the same manner as above. 84% coverage was obtained with 17.5 parts of BT powder, and 85% coverage was obtained with 20.0 parts BT powder, indicating particularly high coverage.

What is claimed is:

1. A method for producing a conductor film, comprising the steps of:
providing a conductor paste for rapid firing, the paste comprising conductive metallic powder comprising nickel powder as a main component, and barium titanate ceramic powder with a mean particle diameter of 10 nm to 80 nm as an additive;
applying the conductor paste to a ceramic green sheet; and
firing the applied conductor paste along with the green sheet under rapid heating conditions where a heating rate is at least 600° C./hr from room temperature to the maximum firing temperature, and the maximum firing temperature is 1000° C. to 1400° C.

2. The method according to claim 1, wherein the mean particle diameter of the conductive metallic powder is 0.05 μm to 0.5 μm.

3. The method according to claim 1, wherein the content of the barium titanate ceramic powder is 5 to 25 mass parts per 100 mass parts of the conductive metallic powder.

4. The method according to claim 1, wherein the heating rate is 1500 to 4000° C./hr.

5. The method according to claim 1, wherein the firing step is carried out in a reducing atmosphere containing 1 to 5 mol % H₂.

6. The method according to claim 1, further comprising cooling the fired product after the maximum firing temperature has been reached where a cooling rate is 200 to 7200° C./hr.

7. The method according to claim 1, further comprising stacking a plurality of the ceramic green sheet to which the conductor paste has been applied before the firing step thereby forming a multi-layered ceramic capacitor (MLCC).
